(19) United States
(12) Patent Application Publication
(10) Pub. No.: US 2014/0084670 A1
(43) Pub. Date: Mar. 27, 2014

(54) Safety Wheel and Tire Assembly

(71) Applicant: Lupe Sanchez, SR., Houston, TX (US)

(72) Inventor: Lupe Sanchez, SR., Houston, TX (US)

(21) Appl. No.: 13/624,588

(22) Filed: Sep. 21, 2012

(51) Int. Cl. B60B 11/06

(52) U.S. Cl. 301/11.1; 301/13.1

(57) ABSTRACT

A metal safety wheel has a center disk and an outer, perimeter flange with a solid rubber tire mounted thereon. The wheel and tire assembly has an outside diameter slightly less than that of a conventional pneumatic wheel and tire assembly with which it may be co-mounted on a vehicle's axle. If the pneumatic tire deflates due to a puncture or blowout, the solid tire and wheel assembly will support the axle on which it is mounted with a loss in height of only half the difference in the tires' outside diameters. The vehicle may, therefore, be driven safely at reduced speed without loss of control.

### CROSS-REFERENCE TO RELATED APPLICATIONS

None

### STATEMENT REGARDING FEDERALLY SPONSORED RESEARCH OR DEVELOPMENT

Not Applicable

### BACKGROUND OF THE INVENTION

1. Field of the Invention

This invention relates motor vehicle wheel and tire assemblies. More particularly, it relates to solid tire wheel assemblies for coaxial mounting with conventional, pneumatic tire wheel assemblies.

2. Description of the Related Art Including Information Disclosed Under 37 CFR 1.97 and 1.98.

Most over-the-road trucks and tractor-trailers are equipped with one or more axles having multiple wheels per side. However, the front axle of such trucks typically has only a single wheel per side. By way of example, the common “18-wheeler” configuration features a tractor having a front steering axle with two wheels (one on each side) and two, driven rear axles each having a total of four wheels. The trailer has two rear axles with four wheels each.

In this configuration, all axles but the front axle have some degree of redundancy—a blowout of one tire will not leave the axle unsupported. This, however, is not true for the front axle. The blowout of a front tire can result in a loss-of-control accident. With the advent of radial tires (taking over from the older cross-ply or bias ply type), it has been found that the tire is much more prone to detach from the rim in the event of a puncture or blowout which can make a bad situation even worse.

To address this problem, various “safety wheels” have been proposed. For example, U.S. Pat. No. 1,712,322 describes an auxiliary or emergency vehicle wheel that is “automatically brought into play or ground contact upon partial deflation of the regular motor vehicle tire and also upon complete collapse of the latter for the purpose of supporting the motor vehicle and permitting continued travel thereof with liability of injury to the deflated pneumatic tire structure eliminated.”

U.S. Pat. No. 6,217,125 describes a safety wheel assembly that uses spacer mounting nuts to allow the mounting of a spare or second wheel and tire on an existing motor vehicle wheel mount assembly. The primary wheel and tire of a vehicle are normally mounted using lug or mounting bolts. These bolts are then used to secure the primary tire with the spacer mounting nut which thereby provides for mounting the spare wheel and tire outwardly of the primary wheel relative to the vehicle. The two tires and wheels are spaced such as not to contact one to the other. The spare tire is a smaller diameter than the primary wheel.

U.S. Pat. No. 5,551,762 describes an auxiliary wheel assembly for supporting a vehicle wheel having a flat tire. The device includes an auxiliary wheel of smaller diameter relative to the vehicle wheel. A mounting assembly secures the auxiliary wheel concentrically adjacent to the vehicle wheel and includes a plurality of brackets permitting movement of the auxiliary wheel in a plane parallel to the vehicle wheel while precluding axial movement of the auxiliary wheel relative to the vehicle wheel during cornering.

### BRIEF SUMMARY OF THE INVENTION

In one particular representative embodiment, the invention comprises a metal wheel having a center disk and an outer, perimeter flange with a solid rubber tire mounted thereon. The wheel and tire assembly has an outside diameter slightly less than that of a conventional pneumatic wheel and tire assembly with which it may be co-mounted on a vehicle's axle. If the pneumatic tire deflates due to a puncture or blowout, the axle will be supported by the solid tire and wheel assembly with a loss in height of only half the difference in the tires' outside diameters. The vehicle may, therefore, be driven safely at reduced speed without loss of control.

In another embodiment of the invention, a wheel is provided with two rims—one for mounting a conventional, pneumatic tire and another for mounting a solid rubber tire outboard of the pneumatic tire. The solid rubber tire has an outside diameter which is less than the outside diameter of the pneumatic tire when properly inflated. If the pneumatic tire suffers a puncture or blowout, the solid rubber tire will support the axle on which the assembly is mounted.

### BRIEF DESCRIPTION OF THE SEVERAL VIEWS OF THE DRAWING(S)

FIG. 1 is a side view of a wheel and tire assembly according to a first embodiment of the invention.

FIG. 1A is a cross-sectional view of the wheel and tire assembly shown in FIG. 1 taken along line A-A of FIG. 1.

FIG. 2A is a cross-sectional view of a wheel and tire assembly according to a second embodiment of the invention.

FIG. 2B is a partial front view of the wheel and tire assembly shown in FIG. 2A.

FIG. 2C is an exploded, perspective view of the wheel and tire assembly shown in FIG. 2A.

FIG. 3A is a cross-sectional view of a wheel and tire assembly according to a third embodiment of the invention.

FIG. 3B is a partial front view of the wheel and tire assembly shown in FIG. 3A.

FIG. 3C is a partially exploded, perspective view of the wheel and tire assembly shown in FIG. 3A with a conventional wheel and tire with which it may be paired shown in phantom.

FIG. 4A is a cross-sectional view of a wheel and tire assembly according to a fourth embodiment of the invention.

FIG. 4B is a partial front view of the wheel and tire assembly shown in FIG. 4A.

FIG. 4C is a partially exploded, perspective view of the wheel and tire assembly shown in FIG. 4A with a conventional wheel and tire with which it may be paired shown in phantom.

### DETAILED DESCRIPTION OF THE INVENTION

The invention may best be understood by reference to the exemplary embodiments illustrated in the drawing figures.

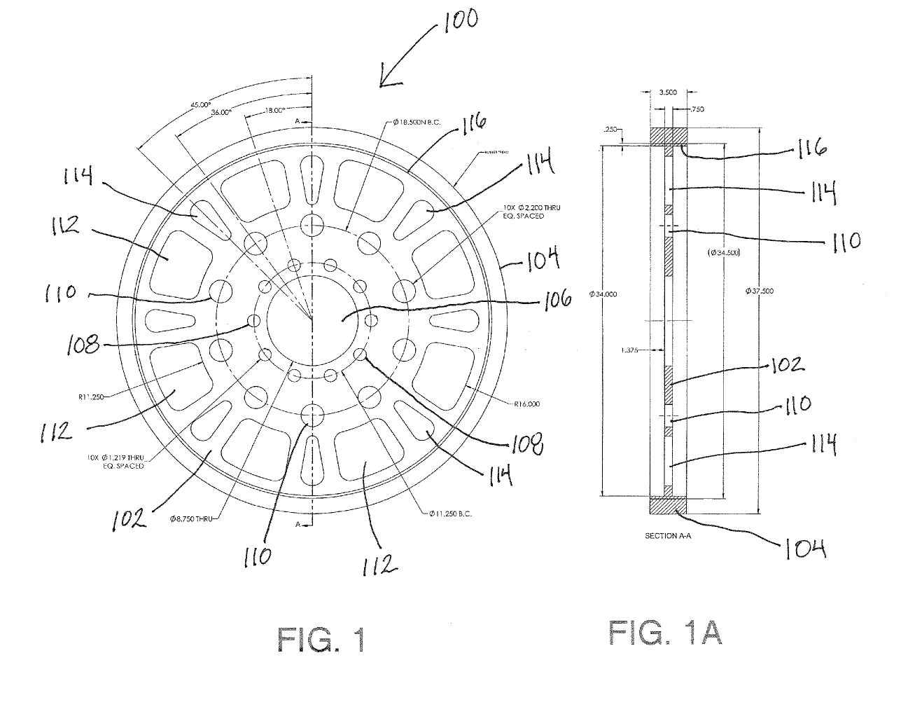

Referring to FIG. 1, wheel and tire assembly 100 according to a first embodiment of the invention is shown. Metal wheel 102 comprises a disk having a central opening 106 which may be sized to accommodate the projecting hub of a rotating assembly attached to a vehicle's axle. A plurality of lug holes 108 may be arranged in a generally circular array around hub opening 106. Lug holes 108 may be sized and spaced to accommodate lug studs projecting from a rotating assembly attached to a vehicle's axle or lug bolts which engage threaded bores on a rotating assembly attached to a vehicle's axle.

The embodiment illustrated in FIGS. 1 and 1A also comprises optional circular openings 110 in wheel 102, larger perimeter openings 112 and smaller perimeter openings 114. These openings may be decorative but also serve to reduce the weight of wheel 102.

Perimeter flange 116 is located at the outer circumference of wheel 102. Perimeter flange 116 may be integral with the disk portion of wheel 102 or may be a separate piece attached to the disk portion of wheel 102.

Wheel 102 may be fabricated of any suitable material using techniques well-known in the art. In one particular preferred embodiment, wheel 102 is formed by machining an aluminum alloy blank. Forging, stamping, casting and welding are other representative forming techniques that may be used for metal wheels according to the invention. In certain embodiments, polymer and/or composite materials may be employed to fabricate wheel 102.

Tire 104 is mounted on the outside of perimeter flange 116. In the illustrated embodiment, tire 104 is a solid rubber tire and has an interference fit with flange 116. Solid tire 104 may be pressed onto flange 116. In certain other embodiments, an adhesive may be used to attach or additionally secure tire 104 to flange 116. One particular preferred adhesive is a cyanoacrylate adhesive. In yet other embodiments, solid tire 104 may be molded to flange 116. Tire 104 may be formed of a synthetic polymer such as polyurethane.

Certain dimensions of a representative embodiment are shown in FIGS. 1 and 1A. It should be appreciated that these dimensions are for illustration purposes only and a wheel and tire assembly according to the invention may have other dimensions.

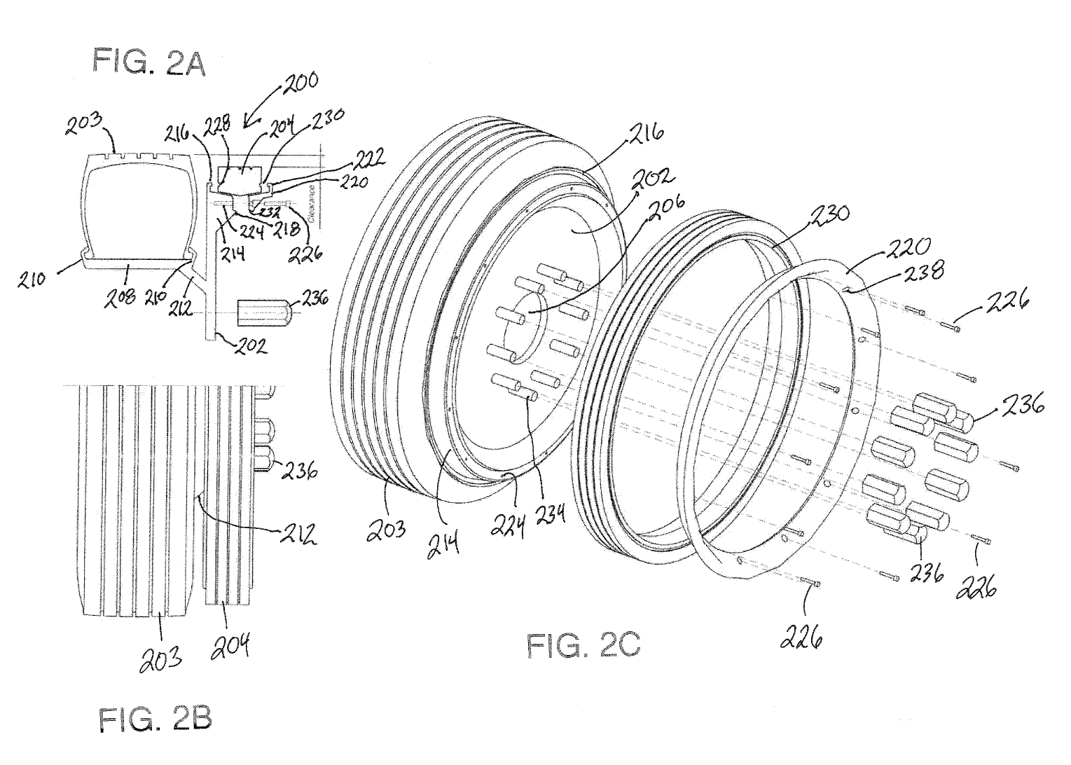

Referring now to FIGS. 2A, 2B and 2C, a second representative embodiment of the invention is illustrated. In this embodiment, wheel and tire assembly 200 comprises wheel 202 which has two, separate rims—inner rim 208 and outer rim 214. Inner rim 208 has an opposing pair of lips 210 for engaging the bead of pneumatic tire 203. Pneumatic tire 203 may be a tube-type tire or a tubeless tire. Outer rim 214 is a split rim and is configured to engage solid tire 204. Solid tire 204 may be formed of natural or synthetic rubber or a synthetic polymer such as polyurethane.

Metal wheel 202 comprises a disk having a central opening 206 which may be sized to accommodate the projecting hub of a rotating assembly attached to a vehicle's axle. A plurality of lug holes may be arranged in a generally circular array around hub opening 206. Lug holes 208 may be sized and spaced to accommodate lug studs 234 projecting from a rotating assembly attached to a vehicle's axle or lug bolts which engage threaded bores on a rotating assembly attached to a vehicle's axle.

Pneumatic tire rim 208 is attached to the central disk portion of wheel 202 by connector 212.

Solid tire 204 is mounted on rim 214 and secured by clamping ring 220. Rim 214 may include threaded bores 224 and annular protuberance 218 which engages surface 232 of clamping ring 220 when clamping ring 220 is attached to rim 214 by machine screws 226 which are inserted in through holes 238 in clamping ring 220 and engage threaded bores 224. Surface 232 of clamping ring 220 may transfer load from solid tire 204 to rim 214 by bearing against annular protuberance 218. In this way, loading of machine screws 226 in shear may be avoided.

Rim 214 includes inner annular rib 216 and clamping ring 220 includes opposing, outer annular rib 222. Solid rubber tire 204 has inner annular groove 228 on its inner sidewall and opposing outer annular groove 230 on its outer sidewall. Grooves 228 and 230 are sized and spaced to engage annular ribs 216 and 222, respectively, when solid tire 204 is secured to rim 214 with clamping ring 220.

In the embodiment illustrated in FIG. 2C, wheel 202 is shown mounted on projecting lug studs 234 of a rotating assembly attached to a vehicle's axle. Wheel 202 may be secured thereon by means of lug nuts 236. It will be appreciated by those skilled in the art that lug bolts or other mounting means may be used to mount wheel and tire assembly 200 on an axle.

As shown in FIG. 2A, the outer diameter of wheel and tire assembly 200 may be chosen to provide a clearance between the treads of solid tire 204 and the treads of pneumatic tire 203 when tire 203 is inflated. If pneumatic tire 203 were to be punctured or suffer a blowout, the support for the axle would only change by the indicated clearance distance as the load was transferred to safety wheel and tire assembly 200.

Wheel 202 may be fabricated of any suitable material using techniques well-known in the art. In one particular preferred embodiment, wheel 202 is formed by machining an aluminum alloy blank. Forging, stamping, casting and welding are other representative forming techniques that may be used for metal wheels according to the invention. In certain embodiments, polymer and/or composite materials may be employed to fabricate wheel 202.

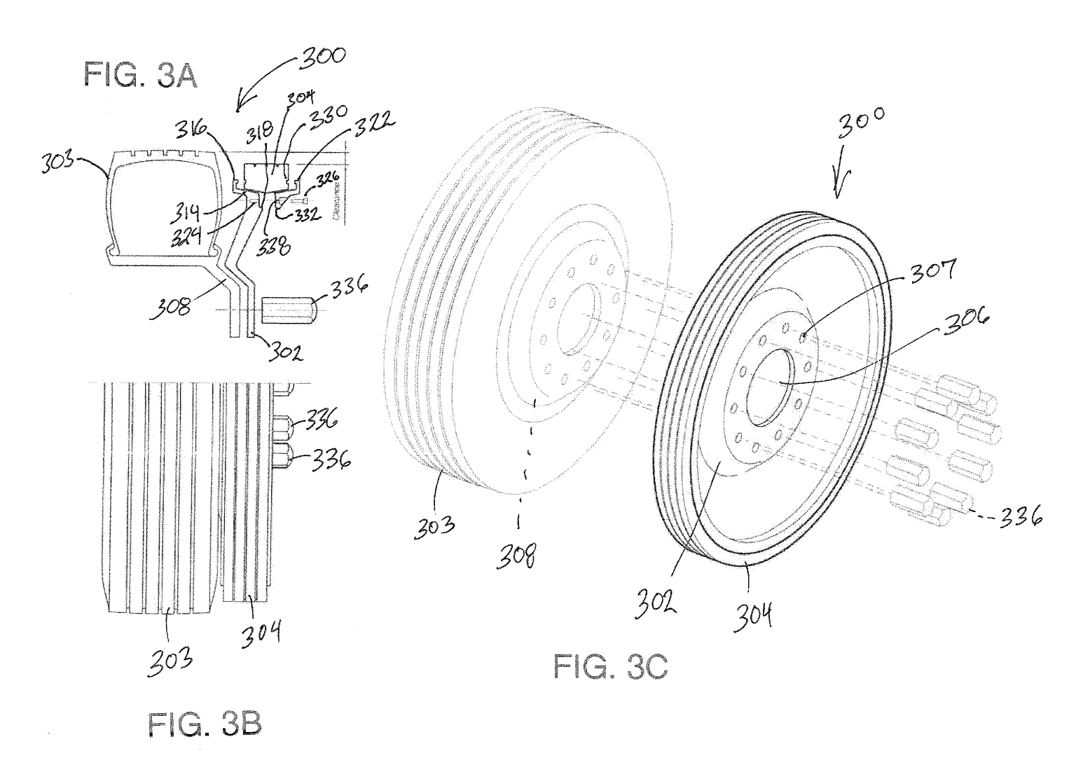

Referring now to FIGS. 3A, 3B and 3C, a third representative embodiment of the invention is illustrated. In this embodiment, wheel and tire assembly 300 is configured for co-mounting with a conventional wheel 308 on an axle. Pneumatic tire 303 is mounted on wheel 308 inboard of wheel and tire assembly 300.

Wheel and tire assembly 300 includes wheel 302 which comprises split rim 314 and clamping ring 320. Rim 314 and clamping ring 320 are configured to engage solid tire 304. Solid tire 304 may be formed of natural or synthetic rubber or a synthetic polymer such as polyurethane.

Metal wheel 302 comprises a disk having a central hub opening 306 which may be sized to accommodate the projecting hub of a rotating assembly attached to a vehicle's axle. A plurality of lug holes 307 may be arranged in a generally circular array around hub opening 306. Lug holes 308 may be sized and spaced to accommodate lug studs projecting from a rotating assembly attached to a vehicle's axle or lug bolts which engage threaded bores on a rotating assembly attached to a vehicle's axle.

Solid rubber tire 304 is mounted on rim 314 and secured by clamping ring 320. Rim 314 may include threaded bores 324 and annular protuberance 318 which engages surface 332 of clamping ring 320 when clamping ring 320 is attached to rim 314 by machine screws 326 which are inserted in through holes 338 in clamping ring 320 and engage threaded bores 324. Surface 332 of clamping ring 320 may transfer load from solid tire 304 to rim 314 by bearing against annular protuberance 318. In this way, loading of machine screws 326 in shear may be avoided.

Rim 314 includes inner annular rib 316 and clamping ring 320 includes opposing, outer annular rib 322. Solid rubber tire 304 has inner annular groove 328 on its inner sidewall and opposing outer annular groove 330 on its outer sidewall. Grooves 328 and 330 are sized and spaced to engage annular ribs 316 and 322, respectively, when solid tire 304 is secured to rim 314 with clamping ring 320.

In the embodiment illustrated in FIG. 3C, wheel 302 is shown in mounting relation with conventional wheel 308 and pneumatic tire 303. Wheels 308 and 302 may be secured together on an axle by means of shared lug nuts 336. It will be appreciated by those skilled in the art that lug bolts or other mounting means may be used to mount wheel and tire assembly 300 on an axle or on a conventional wheel.

As shown in FIG. 3A, the outer diameter of wheel and tire assembly 300 may be chosen so as to provide a clearance between the treads of solid tire 304 and the treads of pneumatic tire 303 when tire 303 is inflated. If pneumatic tire 303 were to be punctured or suffer a blowout, the support for the axle would only change by the indicated clearance distance as the load was transferred to safety wheel and tire assembly 300.

Wheel 302 may be fabricated of any suitable material using techniques well-known in the art. In one particular preferred embodiment, wheel 302 is formed by machining an aluminum alloy blank. Forging, stamping, casting and welding are other representative forming techniques that may be used for metal wheels according to the invention. In certain embodiments, polymer and/or composite materials may be employed to fabricate wheel 302.

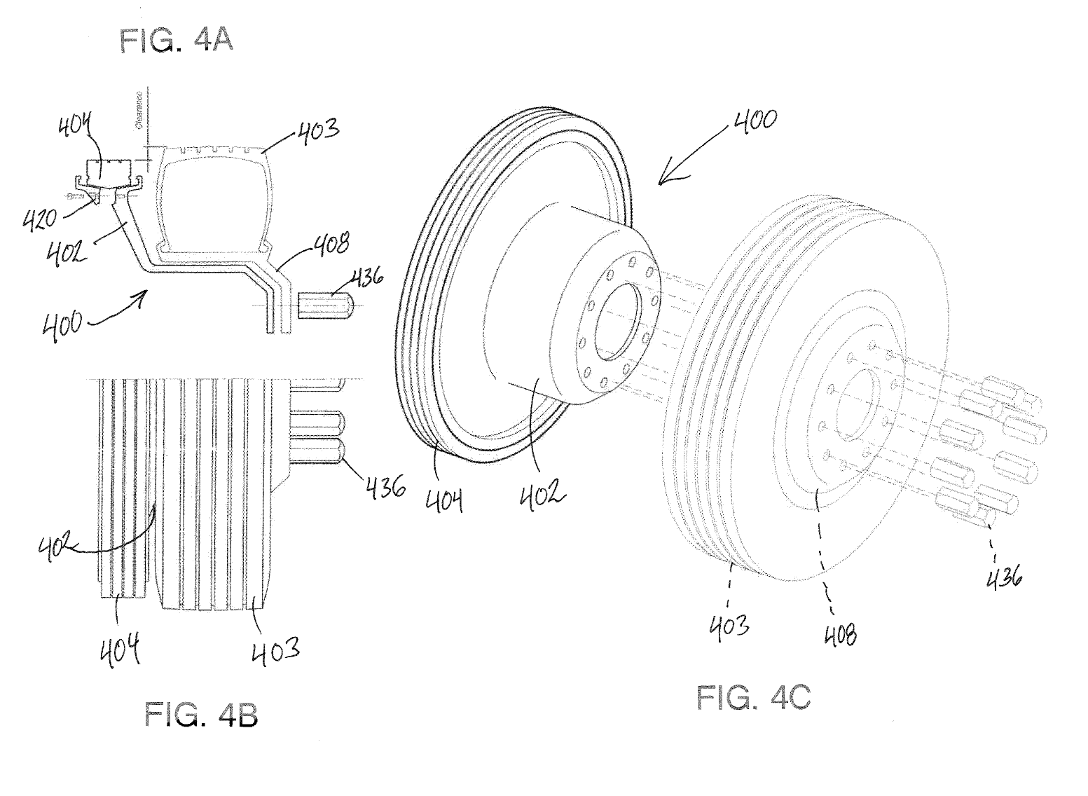

A fourth representative embodiment of the invention is illustrated in FIGS. 4A, 4B and 4C. In this embodiment, wheel and tire assembly 400 is configured for co-mounting with a conventional wheel 408 on an axle. Safety wheel and tire assembly 400 is sized and configured for mounting inboard of conventional pneumatic tire 403 and wheel 408. Otherwise, the embodiment of FIG. 4 is configured similarly to the embodiment shown in FIG. 3.

Wheel and tire assembly 400 includes wheel 402 which comprises split rim 414 and clamping ring 420. Rim 414 and clamping ring 420 are configured to engage solid tire 404. Solid tire 404 may be formed of natural or synthetic rubber or a synthetic polymer such as polyurethane.

Solid tire 404 is mounted on rim 414 and secured by clamping ring 420.

In the embodiment illustrated in FIG. 4C, wheel 402 is shown in mounting relation with conventional wheel 408 and pneumatic tire 403. Wheels 408 and 402 may be secured together on an axle by means of shared lug nuts 436. It will be appreciated by those skilled in the art that lug bolts or other mounting means may be used to mount wheel and tire assembly 400 on an axle or on a conventional wheel.

As shown in FIG. 4A, the outer diameter of wheel and tire assembly 400 may be chosen so as to provide a clearance between the treads of solid tire 404 and the treads of pneumatic tire 403 when tire 403 is inflated. If pneumatic tire 403 were to be punctured or suffer a blowout, the support for the axle would only change by the indicated clearance distance as the load was transferred to safety wheel and tire assembly 400.

Wheel 402 may be fabricated of any suitable material using techniques well-known in the art. In one particular preferred embodiment, wheel 402 is formed by drawing and machining an aluminum alloy blank. Forging, stamping, casting and welding are other representative forming techniques that may be used for metal wheels according to the invention. In certain embodiments, polymer and/or composite materials may be employed to fabricate wheel 402.

Although particular embodiments of the present invention have been shown and described, they are not intended to limit what this patent covers. One skilled in the art will understand that various changes and modifications may be made without departing from the scope of the present invention as literally and equivalently covered by the following claims.

What is claimed is:

1. A safety wheel and tire assembly for a motor vehicle comprising:
a center disk portion having a central axial opening and a plurality of lug holes in a circular array around the central axial opening;
a rim attached to the outer circumference of the center disk portion such that the rim is substantially orthogonal to the disk;
a solid tire mounted on the rim.

2. A safety wheel and tire assembly as recited in claim 1 wherein the solid tire is a rubber tire.

3. A safety wheel and tire assembly as recited in claim 1 wherein the solid tire consists essentially of a synthetic polymer.

4. A safety wheel and tire assembly as recited in claim 3 wherein the synthetic polymer is a polyurethane polymer.

5. A safety wheel and tire assembly as recited in claim 1 wherein the solid tire has an interference fit with the rim.

6. A safety wheel and tire assembly as recited in claim 1 wherein the solid tire is adhesively bonded to the rim.

7. A safety wheel and tire assembly as recited in claim 6 wherein the adhesive is a cyanoacrylate adhesive.

8. A safety wheel and tire assembly as recited in claim 1 wherein the tire is molded to the rim.

9. A safety wheel and tire assembly as recited in claim 1 wherein the outer surface of the rim is cylindrical.

10. A safety wheel and tire assembly as recited in claim 1 wherein the rim is centered on the disk portion.

11. A safety wheel and tire assembly as recited in claim 1 wherein the rim is integral with the disk portion.

12. A safety wheel and tire assembly as recited in claim 1 further comprising:
an axle having a first end connected to the disk portion with one or more fasteners which pass through the lug holes;
a second wheel having a rim configured for mounting a pneumatic tire attached to the first end of the axle adjacent the first wheel; and,
a pneumatic tire mounted on the second wheel.

13. A safety wheel and tire assembly as recited in claim 12 wherein the second wheel is attached to the axle at a position inboard of the disk portion of the first wheel.

14. A safety wheel and tire assembly for a motor vehicle comprising:
a center disk portion having a central axial opening and a plurality of lug holes in a circular array around the central axial opening;
a first rim attached to the outer circumference of the center disk portion;
a solid tire mounted on the first rim;
a second rim attached to the center disk portion at a position intermediate the central axial opening and the outer circumference of the center disk portion and offset from the first rim; and,
a pneumatic tire mounted on the second rim.

15. A safety wheel and tire assembly as recited in claim 14 wherein the first rim is a split rim.

16. A safety wheel and tire assembly as recited in claim 15 further comprising an opposing pair of annular projections on the split rim and a corresponding groove in each sidewall of the solid tire sized and spaced to engage the annular projections.

17. A safety wheel and tire assembly as recited in claim 15 wherein the first member of the split rim has an annular protuberance and the second member of the split rim has a mating surface sized and spaced to bear against the annular protuberance when the split rim members are joined together.

18. A safety wheel and tire assembly for a motor vehicle comprising:
a center disk portion having a central axial opening and a plurality of lug holes in a circular array around the central axial opening;
a split rim having a first member attached to the outer circumference of the center disk portion and a second member connected to the first member with a plurality of removable fasteners; and,
a solid tire mounted on the split rim.

19. A safety wheel and tire assembly as recited in claim 18 further comprising an opposing pair of annular projections on the split rim and a corresponding groove in each sidewall of the solid tire sized and spaced to engage the annular projections.

20. A safety wheel and tire assembly as recited in claim 18 wherein the first member of the split rim has an annular protuberance and the second member of the split rim has a mating surface sized and spaced to bear against the annular protuberance when the split rim members are joined together.
